(19) United States
(12) Patent Application Publication
(10) Pub. No.: US 2015/0279030 A1
(43) Pub. Date: Oct. 1, 2015

(54) Image Processing Apparatus, Image Processing Method, And Non-Transitory Storage Medium Storing Program

(71) Applicant: FUJIFILM Corporation, Tokyo (JP)

(72) Inventor: Daiki HARADA, Ashigarakami-gun (JP)

(21) Appl. No.: 14/675,040

(22) Filed: Mar. 31, 2015

(30) Foreign Application Priority Data
Mar. 31, 2014 (JP) 2014-070967

(51) Int. Cl. G06T 7/00; G06T 5/10; G06T 1/00; G06T 5/00

(52) U.S. Cl. CPC G06T 7/0012; G06T 5/003; G06T 5/10; G06T 1/0007; G06T 2207/10116; G06T 2207/20048; G06T 2207/30004

(57) ABSTRACT

An image processing apparatus includes a first image generator for generating a first image by rotating an original image through a first angle, a second image generator for generating a second image by rotating the original image through a second angle of 90°×n, where n is an integer, that is closest to the first angle, and a display unit for displaying the first image and the second image for comparison with each other.

### CROSS-REFERENCE TO RELATED APPLICATION

This application is based upon and claims the benefit of priority from Japanese Patent Application No. 2014-070967 filed on Mar. 31, 2014, the contents of which are incorporated herein by reference.

### BACKGROUND OF THE INVENTION

1. Field of the Invention

The present invention relates to an image processing apparatus, an image processing method, and a non-transitory storage medium storing a program for processing an original image into an image suitable for diagnosis.

2. Description of the Related Art

In a process of capturing radiographic images of patients as subjects to be imaged, occasionally it may occur that a radiographic image (original image) of a patient is acquired, which is not suitable for being diagnosed by a doctor due to certain limitations concerning positioning of the patient. If such an original image, which is unfit for diagnosis, is acquired, it is customary to rotate the original image in order to produce a diagnosis-friendly image in a subsequent process.

For example, in a case where radiographic images of a given region of a patient, which are captured at different times, are interpreted by way of comparison in a follow-up observation process, at least one of the radiographic images (original images), which is taken from among images that have been captured respectively in the past and at present, is rotated in order to bring the images of a given region of the patient, which are included in the captured radiographic images, into angular alignment with each other. Consequently, the doctor is able to easily compare the radiographic images with each other.

In general, rotation of images has been widely carried out, as disclosed in Japanese Laid-Open Patent Publication No. 10-285380, Japanese Laid-Open Patent Publication No. 2010-094498, and Japanese Laid-Open Patent Publication No. 2013-218573, for example.

### SUMMARY OF THE INVENTION

Digital images have suffered from a problem in that, in a case where a digital image is rotated through a certain angle other than 90°×n (where n is an integer), the image quality of the digital image is inevitably lowered.

As described above, in a follow-up observation process based on an interpretation carried out by way of comparison, among the two radiographic images captured respectively in the past and at present, at least one of the radiographic images (original image) needs to be rotated in order to bring the radiographic images into angular alignment with each other, even though the image quality thereof may potentially be lowered.

In a case where a single radiographic image is interpreted without comparison to a radiographic image that was captured in the past, i.e., in a case where a presently-captured radiographic image is interpreted and diagnosed by the doctor, as well as in a case where a mammographic radiographic image is interpreted, in order to have the benefit of better image quality, it is the usual practice not to rotate the radiographic image through a certain angle other than 90°×n, even if the image of a given region of the patient, which is included within the radiographic image (original image), is oriented at an angle that is not ideally fit for diagnosis. Deterioration in image quality caused by rotation of the image may be compensated for by various image processing techniques. However, such image processing techniques tend to make subsequent processes complex.

Consequently, two alternatives are available for processing an original image, i.e., rotating the original image through a certain angle for improving diagnostic efficiency, despite the possibility of deterioration in image quality, and preventing the original image from being rotated through an angle other than 90°×n in order to prioritize improved image quality.

An object of the present invention is to provide an image processing apparatus, an image processing method, and a non-transitory storage medium storing a program, for selecting an appropriate radiographic image for a desired diagnostic type by displaying, for comparison, an image that is generated by rotating an original radiographic image through a certain angle other than 90°×n, with possible deterioration in image quality, and an image that is generated by rotating an original radiographic image through an angle of 90°×n in order to ensure the benefit of improved image quality.

According to the present invention, there is provided an image processing apparatus comprising a first image generator for generating a first image by rotating an original image through a first angle, a second image generator for generating a second image by rotating the original image through a second angle of 90°×n, where n is an integer, that is closest to the first angle, and a display unit for displaying the first image and the second image for comparison with each other.

According to the present invention, there also is provided an image processing method for enabling an image processing apparatus to carry out a first step of generating a first image by rotating an original image through a first angle, a second step of generating a second image by rotating the original image through a second angle of 90°×n, where n is an integer, that is closest to the first angle, and a third step of displaying the first image and the second image for comparison with each other.

According to the present invention, there further is provided a non-transitory storage medium storing a program to be executed by an image processing apparatus including a first image generator, a second image generator, and a display unit, the program enabling the image processing apparatus to function to carry out the steps of causing the first image generator to generate a first image by rotating an original image through a first angle, causing the second image generator to generate a second image by rotating the original image through a second angle of 90°×n, where n is an integer, that is closest to the first angle, and causing the display unit to display the first image and the second image for comparison with each other.

According to the present invention, the first image, which is generated by rotating the original image through the first angle, and the second image, which is generated by rotating the original image through the second angle of 90°×n, are displayed for comparison with each other on the display unit.

The first image is an image whose angle is optimized, and in particular, the first image is produced by rotating the original image through a given first angle. However, the image quality of the first image is lowered if the first angle is other than 90°×n. The second image is an image whose image quality is optimized, and in particular, the second image is produced by rotating the original image through the second angle of 90°×n. However, the angle of the second image is not optimized.

Since the two images are displayed for comparison with each other, based on an interpretation of the images, the doctor can select an appropriate radiographic image that is suitable for a desired type of diagnosis. Furthermore, since the second image is an image produced by rotating the original image through the second angle of 90°×n that is closest to the first angle, in a case where the two images are displayed for comparison with each other, the doctor finds it easy to select one of the first image and the second image.

If there are two second angles of 90°×n both of which are closest to the first angle, then images produced by rotating the original image through the respective two second angles may be displayed. Alternatively, in the operation sequence, a smaller one of the two second angles may be used preferentially as the second angle, or a prescribed rule may be applied to use 0° or 180° (vertical rotation) preferentially as the second angle.

The image processing apparatus preferably further includes an angle determiner for determining whether or not the first angle falls within a prescribed angular range including the second angle. If the first angle falls within the prescribed angular range, the display unit preferably displays the first image and the second image for comparison with each other. Therefore, the first image and the second image, which are displayed for comparison with each other on the screen of the display unit, are images displayed at respective angles that are close to each other. Accordingly, the doctor finds it easy to select an appropriate radiographic image that is suitable for a desired diagnostic type.

The image processing apparatus preferably further includes an angular range setter for setting the angular range before the angle determiner determines whether or not the first angle falls within the prescribed angular range. Thus, the doctor can set a desired angular range.

The image processing apparatus preferably further includes an imaging target information acquirer for acquiring information concerning an imaging target included within the original image, before the angle determiner determines whether or not the first angle falls within the prescribed angular range, and an angular range setter for setting the angular range depending on the imaging target, on the basis of the information concerning the imaging target, which has been acquired by the imaging target information acquirer. With this arrangement, an appropriate angular range suitable for an imaging target, such as the breast of a subject, can automatically be set.

If the first angle falls outside of the angular range, then since the angular difference between the first image and the second image becomes excessively large, the doctor may find it difficult to select one of the first image and the second image, even though both images are displayed for comparison with each other on the screen of the display unit. In this case, the angle determiner may inhibit the second image generator from generating the second image. In addition, the display unit may display only the first image on the screen, or may display the original image and the first image for comparison with each other on the screen.

The second angle may be an angle corresponding to a vertical direction or a horizontal direction on the original image or a screen of the display unit. The display unit may display the first image and the second image side by side.

The image processing apparatus may further include a selector for selecting as a diagnostic image at least one of the first image and the second image, which are displayed on the display unit. In this manner, it is possible to select and finalize an image based on which a diagnosis of the imaging target included within the original image will be performed.

The image processing apparatus may further include an output unit for outputting the first image and the second image, which are displayed on the display unit. The output unit may comprise, for example, a printer for printing the first image and the second image on a radiographic film or a sheet of paper. Alternatively, the output unit may comprise a communications unit for outputting digital image data of the first image and the second image to a picture archiving and communications system (PACS).

The first image generator may generate the first image by displaying the original image together with a line segment or at least two markers in superposed relation on a screen of the display unit, and rotating the original image through the first angle about a central axis on the line segment or on a straight line interconnecting the two markers. As a result, the doctor can easily acquire the first image in a desired manner.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of a radiographic image capturing system in which an image processing apparatus is incorporated according to an embodiment of the present invention;

FIG. 2 is a flowchart of an operation sequence of the image processing apparatus shown in FIG. 1;

FIG. 3A is a diagram showing an original image; and

FIGS. 3B and 3C are diagrams showing a first image, which is generated by rotating the original image shown in FIG. 3A through a certain angle.

### DESCRIPTION OF THE PREFERRED EMBODIMENTS

An image processing apparatus according to a preferred embodiment of the present invention, in relation to an image processing method and a non-transitory storage medium storing a program, will be described in detail below with reference to the accompanying drawings.

### Configuration of the Embodiment

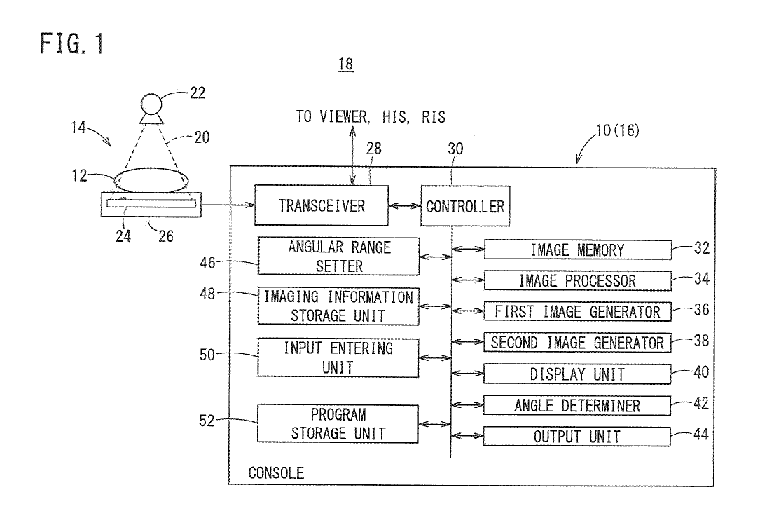

As shown in FIG. 1, an image processing apparatus 10 according to a preferred embodiment of the present invention is incorporated in a radiographic image capturing system 18, which includes a radiographic image capturing apparatus 14 for capturing a radiographic image of a subject 12, and a console 16 for controlling the radiographic image capturing apparatus 14. More specifically, the image processing apparatus 10 functions as the console 16. Therefore, in the following description, the console 16 may also be referred to as the image processing apparatus 10.

The radiographic image capturing apparatus 14 includes a radiation source 22 for emitting radiation 20, and an image-capturing table 26 in which a radiation detector 24 is housed for detecting radiation 20 and converting the radiation 20 into electric signals. In a case where the subject 12 is placed on the image-capturing table 26 and radiation 20 is emitted from the radiation source 22 and applied to the subject 12, the radiation 20 is transmitted through the subject 12 and projected onto a detecting surface of the radiation detector 24, which converts the radiation 20 into a radiographic image (original image) representing the subject 12. The radiographic image is output from the radiation detector 24 to the image processing apparatus 10.

The radiation detector 24 may comprise, for example, an indirect-conversion radiation detector for converting radiation 20 into phosphorescent light in a predetermined wavelength range with a scintillator, and then converting the phosphorescent light into electric signals. Alternatively, the radiation detector 24 may comprise a direct-conversion radiation detector for directly converting radiation 20 into electric signals. Since the radiographic image capturing apparatus 14 is of a known nature, the radiographic image capturing apparatus 14 will not be described in detail below. Details of the console 16, which controls the radiographic image capturing apparatus 14 in order to capture radiographic images, also are known in the art, and hence details of the console 16 are omitted from illustration in FIG. 1.

The image processing apparatus 10 includes a transceiver 28 for sending signals to and receiving signals from the radiographic image capturing apparatus 14, as well as for sending signals to and receiving signals from a hospital information system (HIS) and a radiologic information system (RIS) via an in-house network, not shown. The image processing apparatus 10 further includes a controller 30 for controlling various components in the image processing apparatus 10.

The console 16 includes an image memory 32, an image processor 34, a first image generator 36, a second image generator 38, a display unit 40, an angle determiner 42, an output unit 44, an angular range setter 46, an imaging information storage unit (imaging target information acquirer) 48, an input entering unit (selector) 50, and a program storage unit (non-transitory storage medium) 52, all of which are connected to the controller 30.

The image memory 32 stores various images including a radiographic image that the transceiver 28 receives from the radiographic image capturing apparatus 14. The image processor 34 performs a predetermined image processing routine on the radiographic image as well as on other images that are stored in the image memory 32.

The first image generator 36 reads the radiographic image stored in the image memory 32, and rotates the read radiographic image through a first angle θ1, thereby generating a first image. The second image generator 38 reads the radiographic image stored in the image memory 32, and rotates the read radiographic image through a second angle θ2, which is represented by 90°×n (n: integer) and is closest to the first angle θ1, thereby generating a second image.

The radiographic image, from which the first and second images are generated, respectively, by the first image generator 36 and the second image generator 38, refers to either the radiographic image that the transceiver 28 acquires from the radiographic image capturing apparatus 14 and which is stored in the image memory 32, or the radiographic image that the image processor 34 reads from the image memory 32 and which is processed and stored in the image memory 32. The radiographic image from which the first image is generated by the first image generator 36 and from which the second image is generated by the second image generator 38 will hereinafter be referred to as an “original image”.

Providing that the original image and the first image include a given region of the subject 12, the first angle θ1 refers to an angle of the given region of the subject 12, which is included in another image to be compared with the first image for diagnostic interpretation. For example, the other image may be an image that was captured in the past and includes the given region of the subject 12.

The second angle θ2 refers to an angle, which is represented by 90°×n and is closest to the first angle θ1, selected from among angles corresponding to vertical and horizontal directions on the original image, or from among angles corresponding to vertical and horizontal directions on the screen of the display unit 40.

The display unit 40 displays the original image, the first image, and/or the second image. More specifically, the display unit 40 displays the original image, the first image, or the second image individually, or displays at least two of the original image, the first image, and the second image side by side for comparison with each other.

The angle determiner 42 determines whether or not the first angle θ1 falls within a prescribed angular range Δθ (Δθ=−α to +α) including the second angle θ2. Stated otherwise, the angle determiner 42 determines whether or not the first image is an image that is rotated within the angular range Δθ from the original image. If the first angle θ1 falls within the angular range Δθ (−α≦θ1≦+α), then the angle determiner 42 allows the display unit 40 to display the first image and the second image for comparison with each other.

On the other hand, if the first angle θ1 falls outside of the angular range Δθ (−α>θ1 or θ1>+α), then the angle determiner 42 inhibits the second image generator 38 from generating the second image. In this case, the display unit 40 displays the original image or the first image only, or displays the original image and the first image for comparison with each other.

The determined result from the angle determiner 42 is sent respectively to the first image generator 36, the second image generator 38, and the display unit 40.

The angular range Δθ may be a prescribed angular range, which is set uniformly regardless of the region in which the subject 12 is imaged. For example, the angular range Δθ may be a prescribed angular range having a central angle represented by the second angle θ2 (=90°×n) (Δθ=(90°×n−α) to (90°×n+α)). Alternatively, the angular range Δθ may be an angular range, which is set differently for different regions to be imaged of the subject 12. According to the latter alternative, α may be made smaller in order to reduce the angular range Δθ for a breast of the subject 12 to be imaged, or α may be made greater in order to increase the angular range Δθ for a hand or a foot of the subject 12 to be imaged.

The output unit 44 may comprise, for example, a printer for printing the original image, the first image, and/or the second image, which are displayed on the display unit 40, on a radiographic film or a sheet of paper, or a communications unit for outputting image data (digital image data) of the displayed images to a PACS.

The angular range setter 46 sets an angular range Δθ, and sends the set angular range Δθ to the angle determiner 42.

The imaging information storage unit 48 stores information (imaging target information) concerning a given region of the subject 12, which serves as an imaging target that is included within the original image. The imaging target information, which is stored in the imaging information storage unit 48, includes various items of information concerning the given region, e.g., a breast, a hand, or a foot, of the subject 12, which include an image capturing order and image capturing conditions, etc., for radiographic images to be captured of the given region of the subject 12 by the radiographic image capturing apparatus 14.

By referring to the imaging target information that is stored in the imaging information storage unit 48, the angular range setter 46 is capable of automatically setting an angular range Δθ for a specified region to be imaged of the subject 12.

The input entering unit 50 comprises any of various input devices including a keyboard, a mouse, etc., operated by the doctor (or radiologist). If the display unit 40 comprises a touch panel, then the input entering unit 50 may be an operable portion of the touch panel, which is operated by the doctor.

The doctor operates the input entering unit 50 in order to enter a desired angular range. The angular range setter 46 receives the entered angular range, and sets the received angular range as an angular range Δθ. The angular range Δθ, which is set by the doctor, may be an angular range Δθ that is set uniformly, regardless of which region of the subject 12 is to be imaged. Alternatively, as described above, the angular range Δθ may be an angular range Δθ that is set differently for different regions to be imaged of the subject 12.

In the event that the doctor operates the input entering unit 50 in order to enter a first angle θ1 while viewing the original image that is displayed on the display unit 40, or more specifically, in the event that the display unit 40 and the input entering unit 50 jointly make up a touch panel, and the doctor operates the touch panel in order to enter an instruction to rotate the original image through a first angle θ1, the first image generator 36 receives the entered first angle θ1. Based thereon, the first image generator 36 rotates the original image through the received first angle θ1, thereby generating a first image.

The controller 30 reads and executes a program stored in the program storage unit 52, which comprises a non-transitory storage medium, so as to control the various components of the image processing apparatus 10 and thereby carry out the following operation sequence.

### Operations of the Present Embodiment

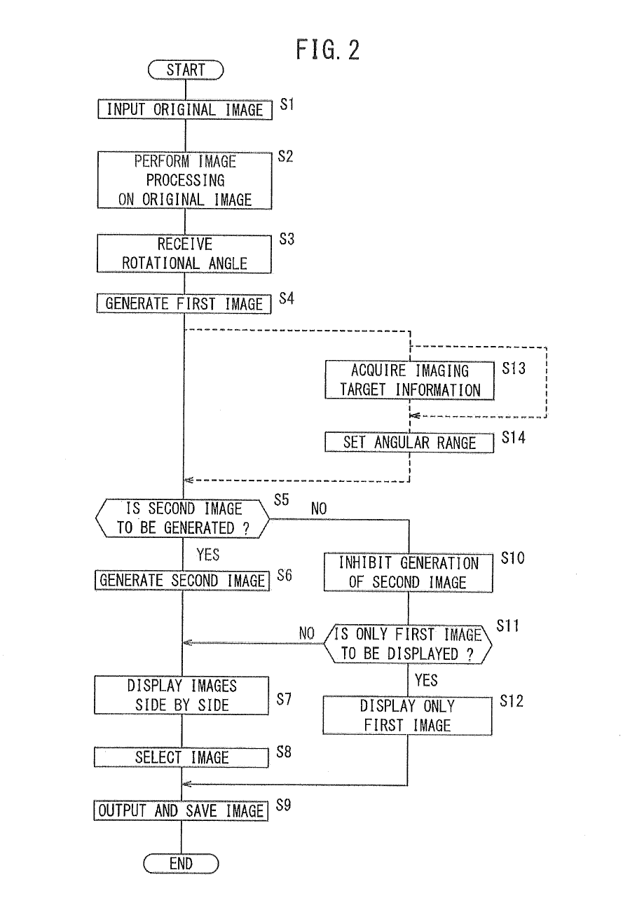

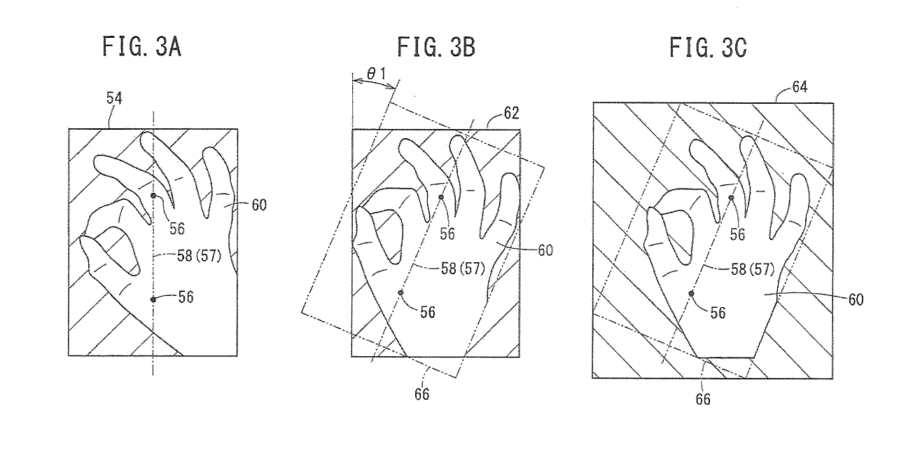

The radiographic image capturing system 18, in which the image processing apparatus 10 according to the present embodiment is incorporated, is basically configured as described above. An operation sequence (image processing method) of the image processing apparatus 10 will be described below with reference to FIGS. 2 through 3C, as well as FIG. 1 as necessary.

It is assumed that the display unit 40 and the input entering unit 50 jointly make up a touch panel. A radiographic image, which is processed and stored by the image processor 34, is used as an original image from which first and second images are generated.

In step S1 of FIG. 2, the transceiver 28 (see FIG. 1) receives a radiographic image from the radiographic image capturing apparatus 14. The controller 30 stores the received radiographic image as an original image in the image memory 32.

In step S2, the image processor 34 reads the original image that was stored in the image memory 32, and performs a prescribed image processing routine on the read original image. The original image, after having been subjected to image processing, is stored again in the image memory 32.

In step S3, as shown in FIG. 3A, the first image generator 36 displays on the screen of the display unit 40 a processed original image 54, along with a straight line 58 including a line segment 57 that interconnects two markers 56, in superposed relation to each other. As shown in FIG. 3A, the original image 54 includes, for example, a subject image 60 representing the right hand of the subject 12. In other words, the original image 54 is a radiographic image of the right hand of the subject 12, which is captured in a radiographic image capturing process carried out by the radiographic image capturing apparatus 14.

If the doctor determines that it is necessary to rotate the original image 54 in order to facilitate diagnostic interpretation by way of comparison, while at the same time observing the original image 54 that is displayed on the screen of the display unit 40, the doctor operates the input entering unit 50 in order to enter a first angle θ1. At this time, the first image generator 36 receives the entered first angle θ1.

More specifically, the finger of the doctor touches the operable portion of the touch panel, which includes the input entering unit 50, and specifies two locations on the original image 54, whereupon the two markers 56 and the straight line 58 including the line segment 57 interconnecting the markers 56 are displayed. Thereafter, the doctor rotates the original image 54 through a desired first angle θ1 about a central axis on the displayed straight line 58, thereby entering the first angle θ1. More specifically, while touching the straight line 58, the doctor rotates the straight line 58 through a first angle θ1. Alternatively, while touching the two markers 56, the doctor may rotate the two markers 56 through a first angle θ1, thereby rotating the original image 54 in its entirety about the central axis on the straight line 58.

As a result, in step S4, by rotating the original image 54 through the first angle θ1, the first image generator 36 generates a first image 62, which is shown in FIG. 3B, or a first image 64, which is shown in FIG. 3C, and displays the first image 62 or the first image 64 on the screen of the display unit 40.

The first image 62 shown in FIG. 3B is an image that is produced by rotating the original image 54 through the first angle θ1 while maintaining the same image size as the original image 54, aligning the orientation of the first image 62 with the orientation of the original image 54, and filling the background area of the subject image 60. The filled background area is effective to reduce glare at the time that the doctor observes the first image 62.

In FIG. 3B, the two-dot-and-dash lines represent a frame 66 of the original image 54, which has been rotated through the first angle θ1. The display unit 40 also displays the frame 66 on the screen. The displayed frame 66 makes it possible for the doctor to recognize that the first image 62 is an image generated by rotation of the original image 54.

The first image 64 shown in FIG. 3C is an image produced by rotating the original image 54 through the first angle θ1, creating a frame that touches the four vertices of the frame 66 indicated by the two-dot-and-dash lines, aligning the orientation of the first image 64 with the orientation of the original image 54, and filling the background area of the subject image 60. The image size of the first image 64 is greater than that of the original image 54. The filled background area reduces glare at the time that the doctor observes the first image 64. The display unit 40 also displays the frame 66 on the screen, thus making it clear that the first image 64 is an image that was generated by rotation of the original image 54.

In the above description, a case has been described in which the original image 54 is rotated by rotation of the markers 56 or the straight line 58. However, a text box, which functions as the input entering unit 50, may be displayed on the screen of the display unit 40, and the doctor may enter a first angle θ1 into the text box, thereby causing the original image 54 to rotate through the first angle θ1 in order to generate the first image 62 or 64.

In step S5, after the first image 62 or 64 has been generated, the angle determiner 42 determines whether or not the first angle θ1 falls within the angular range Δθ including the second angle θ2. Stated otherwise, the angle determiner 42 determines whether or not a second image is to be generated.

If the first angle θ1 falls within the angular range Δθ (step S5: YES), the angle determiner 42 permits the second image generator 38 to generate a second image, and in step S6, sends the determined result to the second image generator 38, etc. On the basis of the determined result, the second image generator 38 reads the original image 54 from the image memory 32, and rotates the read original image 54 through the second angle θ2, thereby generating the second image.

In step S7, the display unit 40 is capable of displaying the second image together with the first image 62 or the first image 64 side by side on the screen. In step S8, the doctor operates the input entering unit 50 in order to select an image suitable for diagnostic interpretation.

For example, if the doctor performs a follow-up observation process on the right hand of the subject 12, for interpreting and comparing the radiographic images, the doctor needs to compare a presently-captured radiographic image with a radiographic image that was captured in the past. Therefore, providing that the first image 62 or 64 is in angular alignment with a radiographic image that was captured in the past, the doctor selects the first image 62 or 64, even though the image quality of the first image 62 or 64 may possibly be lowered due to rotation of the image through the first angle θ1.

On the other hand, if the doctor interprets a single presently-captured radiographic image, or if the doctor places priority on image quality, as is the case with interpreting a mammographic image of the subject 12, the doctor selects the second image, which is of better image quality, even though the second image is not in angular alignment with a radiographic image that was captured in the past.

In step S8, the doctor may also select both the first image 62 or 64 and the second image.

In step S9, the output unit 44 outputs the image that was selected by the doctor. The image selected in step S8 is saved in the image memory 32, and the saved image is sent from the transceiver 28 through the in-house network to a viewer, the HIS, and the RIS.

If the first angle θ1 falls outside of the angular range Δθ (step S5: NO), then the angle determiner 42 inhibits the second image generator 38 from generating the second image, and in step S10, sends the determined result to the second image generator 38, etc.

At this time, the display unit 40 displays only the first image 62 or the first image 64 on the screen (step S11: YES; step S12). After step S12, the first image 62 or the first image 64 is output and saved in step S9.

Alternatively, the display unit 40 may display the original image 54 and the first image 62 or the first image 64 side by side on the screen (step S11: NO; step S7). After the original image 54 and the first image 62 or the first image 64 have been displayed side by side in step S7, in step S8, the doctor selects the original image 54 or the first image 62 or 64.

In the above description, the angular range Δθ is a preset value. For setting an angular range Δθ, steps S13 and S14 are carried out in the following manner prior to step S5.

In step S13, after step S4, if the imaging target information of the subject 12 concerning the original image 54 has been stored in the imaging information storage unit 48, then the angular range setter 46 reads the imaging target information from the imaging information storage unit 48. In step S14, the angular range setter 46 sets an angular range Δθ by referring to the read imaging target information, and outputs the set angular range Δθ to the angle determiner 42.

Alternatively, if the doctor wishes to set an angular range Δθ, then in step S14, after step S4, the doctor may operate the input entering unit 50 in order to enter a desired angular range Δθ. The angular range setter 46 may output the entered angular range Δθ to the angle determiner 42.

### Advantages of the Embodiment

With the image processing apparatus 10, the image processing method, and the program storage unit 52 storing the program according to the present embodiment, the first image 62 or 64, which is produced by rotating the original image 54 through the first angle θ1, and the second image, which is produced by rotating the original image 54 through the second angle θ2 of 90°×n that is closest to the first angle θ1, are displayed for comparison with each other on the screen of the display unit 40.

The first image 62 or 64 is an image whose angle is optimized, and in particular, the first image is produced by rotating the original image 54 through the first angle θ1. However, the image quality of the first image is lowered if the first angle θ1 is other than 90°×n. The second image is an image whose image quality is optimized, and in particular, the second image is produced by rotating the original image 54 through the second angle θ2 of 90°×n. However, the angle of the second image is not optimized.

Since the two images are displayed for comparison with each other, based on an interpretation of the images, the doctor can select an appropriate radiographic image suitable for a desired type of diagnosis. Furthermore, since the second image is an image produced by rotating the original image 54 through the second angle θ2 of 90°×n that is closest to the first angle θ1, in a case where the two images are displayed for comparison with each other, the doctor finds it easy to select one of the first image 62 or 64 and the second image.

According to the present embodiment, if there are two second angles θ2 of 90°×n both of which are closest to the first angle θ1, then images produced by rotating the original image through the respective two second angles θ2 may be displayed. Alternatively, in the operation sequence, a smaller one of the two second angles θ2 may be used preferentially as the second angle θ2, or a prescribed rule may be applied to use 0° or 180° (vertical rotation) preferentially as the second angle θ2.

The angle determiner 42 determines whether or not the first angle θ1 falls within an angular range Δθ including the second angle θ2. The first image 62 or 64 and the second image, which are displayed for comparison with each other on the screen of the display unit 40, are images displayed at respective angles that are close to each other. Accordingly, the doctor finds it easy to select an appropriate radiographic image that is suitable for a desired diagnostic type.

The angular range setter 46 sets an angular range Δθ prior to the determining process that is carried out by the angle determiner 42. Thus, the doctor is allowed to set a desired angular range Δθ.

Alternatively, prior to the determining process carried out by the angle determiner 42, the imaging target information of the imaging target (subject image 60), which is included within the original image 54, may be stored in the imaging information storage unit 48, and based on the stored imaging target information, the angular range setter 46 may set an angular range Δθ depending on the subject 12. In this manner, an appropriate angular range Δθ suitable for an imaging target, such as a breast of the subject 12, can automatically be set.

If the first angle θ1 falls outside of the angular range Δθ, then since the angular difference between the first image 62 or 64 and the second image becomes excessively large, the doctor may find it difficult to select one of the first image 62 or 64 and the second image, even though both images are displayed for comparison with each other on the screen of the display unit 40. In this case, the angle determiner 42 inhibits the second image generator 38 from generating the second image. In addition, the display unit 40 displays only the first image 62 or 64 on the screen, or displays the original image 54 and the first image 62 or 64 for comparison with each other on the screen.

If the second angle θ2 is an angle corresponding to a vertical direction or a horizontal direction on the original image 54 or the screen of the display unit 40, the display unit 40 can easily display the first image 62 or 64 and the second image side by side on the screen.

The doctor can operate the input entering unit 50 in order to select as a diagnostic image at least one of the first image 62 or 64 and the second image that are displayed on the display unit 40, or to select as the diagnostic image the original image 54, the first image 62, 64 and/or the second image that is displayed on the display unit 40. In this manner, it is possible to select and finalize an image, based on which a diagnosis of the imaging target included within the original image 54 will be performed.

Since the output unit 44 is added thereto, the image processing apparatus 10 can easily output the original image 54, the first image 62 or 64, and the second image, which are displayed on the display unit 40 through the output unit 44.

The first image generator 36 can generate the first image 62 or 64 by displaying the original image 54 and the straight line 58, including the two markers 56 and the line segment 57, in superposed relation on the screen of the display unit 40, and then rotating the original image 54 through the first angle θ1 about a central axis on the straight line 58 connecting the two markers 56. In this manner, it is easy for the doctor to acquire the desired first image 62 or 64.

The console 16 has been described as functioning as the image processing apparatus 10. However, a viewer that functions as the image processing apparatus 10 may also be used.

In the above description, the second image generator 38 generates the second image by automatically rotating the original image through 90°×n. According to the present embodiment, in a case where the original image has been rotated through 90°×n in response to the doctor operating the input entering unit 50, e.g., by operating the touch panel, the second image generator 38 may accept the rotated original image as the second image. In other words, according to the present embodiment, generation of the second image is a concept that covers both automatic generation of the second image by the second image generator 38, as well as generation of the second image triggered by the doctor operating the input entering unit 50.

Although a preferred embodiment of the present invention and various modifications thereof have been described above, it should be understood that the present invention is not limited to the illustrated embodiment and such modifications. It goes without saying that various changes may be made to the embodiment and such modifications without departing from the scope of the invention as set forth in the appended claims.

What is claimed is:

1. An image processing apparatus comprising:
a first image generator for generating a first image by rotating an original image through a first angle;
a second image generator for generating a second image by rotating the original image through a second angle of 90°×n, where n is an integer, that is closest to the first angle; and
a display unit for displaying the first image and the second image for comparison with each other.

2. The image processing apparatus according to claim 1, further comprising:
an angle determiner for determining whether or not the first angle falls within a prescribed angular range including the second angle;
wherein, if the first angle falls within the prescribed angular range, the display unit displays the first image and the second image for comparison with each other.

3. The image processing apparatus according to claim 2, further comprising:
an angular range setter for setting the angular range before the angle determiner determines whether or not the first angle falls within the prescribed angular range.

4. The image processing apparatus according to claim 2, further comprising:
an imaging target information acquirer for acquiring information concerning an imaging target included within the original image, before the angle determiner determines whether or not the first angle falls within the prescribed angular range; and
an angular range setter for setting the angular range depending on the imaging target, on the basis of the information concerning the imaging target, which has been acquired by the imaging target information acquirer.

5. The image processing apparatus according to claim 2, wherein, if the first angle falls outside of the angular range, the angle determiner inhibits the second image generator from generating the second image; and
the display unit displays only the first image, or displays the original image and the first image for comparison with each other.

6. The image processing apparatus according to claim 1, wherein the second angle is an angle corresponding to a vertical direction or a horizontal direction on the original image or a screen of the display unit; and
the display unit displays the first image and the second image side by side.

7. The image processing apparatus according to claim 1, further comprising:
a selector for selecting as a diagnostic image at least one of the first image and the second image, which are displayed on the display unit.

8. The image processing apparatus according to claim 1, further comprising:
an output unit for outputting the first image and the second image, which are displayed on the display unit.

9. The image processing apparatus according to claim 1, wherein the first image generator generates the first image by displaying the original image together with a line segment or at least two markers in superposed relation on a screen of the display unit, and rotating the original image through the first angle about a central axis on the line segment or on a straight line interconnecting the two markers.

10. An image processing method for enabling an image processing apparatus to carry out:
a first step of generating a first image by rotating an original image through a first angle;
a second step of generating a second image by rotating the original image through a second angle of 90°×n, where n is an integer, that is closest to the first angle; and
a third step of displaying the first image and the second image for comparison with each other.

11. A non-transitory storage medium storing a program to be executed by an image processing apparatus including a first image generator, a second image generator, and a display unit, the program enabling the image processing apparatus to function to carry out the steps of:
causing the first image generator to generate a first image by rotating an original image through a first angle;
causing the second image generator to generate a second image by rotating the original image through a second angle of 90°×n, where n is an integer, that is closest to the first angle; and
causing the display unit to display the first image and the second image for comparison with each other.
